(19) United States
(12) Patent Application Publication
(10) Pub. No.: US 2021/0188253 A1
(43) Pub. Date: Jun. 24, 2021

(54) VEHICLE CORNERING ASSISTANCE SYSTEMS AND METHODS

(71) Applicant: Continental Automotive Systems Inc., Auburn Hills, MI (US)

(72) Inventor: Joseph Brian Burtch, Lake Orion, MI (US)

(21) Appl. No.: 16/725,450

(22) Filed: Dec. 23, 2019

(51) Int. Cl. B60W 30/06; B60W 50/16; B62D 13/00; B60R 11/04

(52) U.S. Cl. CPC B60W 30/06; B60W 50/16; B62D 13/00; B60R 2300/105; B60R 2300/806; B60R 2300/8093; B60R 11/04

(57) ABSTRACT

A system for assisting in the exit of a vehicle from a parking spot includes at least one camera on the vehicle for obtaining one or more images of an object near the parking spot. A sensor is configured to sense a path of the vehicle as the vehicle exits the parking spot. A controller is configured to determine whether a collision between the vehicle and the object is imminent based on the sensed path and the one or more images and initiating a vehicle response if the collision is imminent.

### BACKGROUND

Vehicles may undergo certain cornering situations during operation. These situations include entering or exiting parking spots, and other low speed cornering situations in which the vehicle is moving and also turning. Vehicles may perform cornering in the forward or reverse directions in some examples.

### SUMMARY

A method for assisting in the exit of a vehicle from a parking spot, according to an example of this disclosure, includes obtaining one or more images of an object near the parking spot, sensing a path of the vehicle as the vehicle exits the parking spot, determining whether a collision between the vehicle and the object is imminent based on the sensed path and the one or more images, and initiating a vehicle response if the collision is imminent.

In a further example of the foregoing, the vehicle response includes one or more of a vibration in a seat of the vehicle, an audiovisual response, a steering correction, a pulse in a steering wheel of the vehicle, and a brake activation.

In a further example of any of the foregoing, the method includes determining that the vehicle is located in a parking area.

In a further example of any of the foregoing, the method includes sensing a path of a trailer of the vehicle as the vehicle exits the parking spot and determining whether a collision between the trailer and the object is imminent based on the sensed trailer path and the one or more images.

In a further example of any of the foregoing, the object is an adjacent vehicle.

In a further example of any of the foregoing, the object is a curb.

In a further example of any of the foregoing, one or more images of an object near the vehicle are obtained. The example method includes obtaining one or more images of an object near the vehicle as the vehicle pulls into the parking spot.

In a further example of any of the foregoing, the method stores one or more images obtained as the vehicle pulls into the parking spot on a memory device.

A system for assisting in the exit of a vehicle from a parking spot, according to an example of this disclosure, includes at least one camera on the vehicle for obtaining one or more images of an object near the parking spot. A sensor is configured to sense a path of the vehicle as the vehicle exits the parking spot. A controller is configured to determine whether a collision between the vehicle and the object is imminent based on the sensed path and the one or more images and initiating a vehicle response if the collision is imminent.

In a further example of the foregoing, the camera is disposed on or adjacent a side view mirror of the vehicle.

In a further example of any of the foregoing, the camera includes a fish eye lens.

In a further example of any of the foregoing, the system includes a memory device for storing the one or more images.

In a further example of any of the foregoing, one or more images are obtained as the vehicle pulls into the parking spot.

In a further example of any of the foregoing, the controller is an electronic control unit (ECU).

In a further example of any of the foregoing, the vehicle response includes one or more of a vibration in a seat of the vehicle, an audiovisual response, a steering correction, a pulse in a steering wheel of the vehicle, and a brake activation.

In a further example of any of the foregoing, the controller is configured to determine that the vehicle is located in a parking area.

These and other features may be best understood from the following specification and drawings, the following of which is a brief description.

### BRIEF DESCRIPTION OF THE DRAWINGS

FIG. 1 schematically illustrates an example system for assisting in the cornering of the vehicle.

FIG. 2 a second example system for assisting in the cornering of the vehicle.

FIG. 3A schematically illustrates the example system of FIG. 2 in use.

FIG. 3B schematically illustrates example vehicle responses for the example system shown in FIGS. 2 and 3A.

FIG. 4 illustrates a flow chart of an example method for assisting in the cornering of the vehicle.

### DETAILED DESCRIPTION

In general, this disclosure pertains to systems and methods for assisting the cornering in a vehicle. In some example applications, the systems and methods pertain to assisting in parking situations.

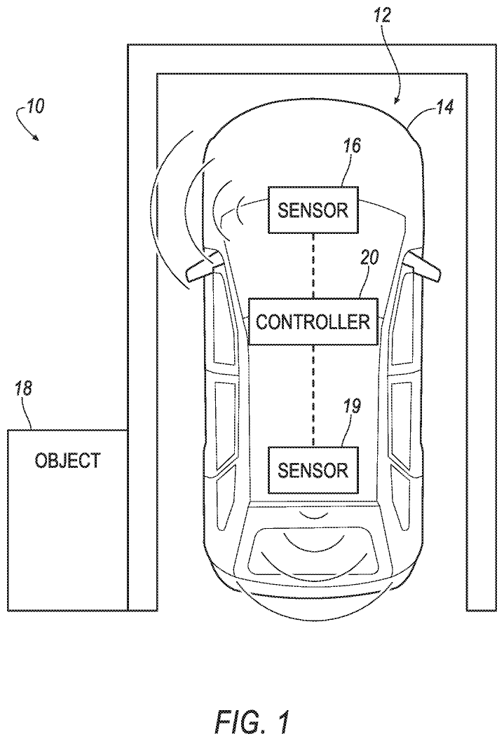

FIG. 1 schematically illustrates an example system 10 for assisting in the cornering of the vehicle 14, the illustrative example being the exit of a vehicle 14 from a parking spot 12. In the examples disclosed herein, the vehicle 14 may exit the parking spot in the forward or reverse direction. In some examples, the vehicle 14 the vehicle may be any type of vehicle, some examples including cars, trucks, motorcycles, buses, recreational vehicles, etc. In some examples, the parking spot 112 may be located in a parking lot, street, driveway, or garage. Although parking situations are disclosed as some examples herein, other cornering applications may benefit from this disclosure.

The example system 10 includes a sensor 16 for sensing an object 18 at a periphery of the vehicle parking spot 12. A sensor 19 senses a path of the vehicle 14 as the vehicle 14 exits the parking spot 12. A controller 20 in communication with the sensors 16, 19 may be programmed to determine whether a collision between the vehicle 14 and the object 18 is imminent based on the information received from the sensors 16, 19 and initiate a vehicle response if the collision is imminent.

In some examples, the sensor 16 may include one or more of a camera, radar sensor, laser, LIDAR sensor and ultrasonic sensor. In some examples, the camera is a surround view camera. Although one sensor 16 is shown in the schematic example of FIG. 1, more sensors may be utilized in some examples. In some examples, the sensor 16 may be located adjacent one or more of a front grill, a side mirror, and a trunk area.

In some examples, the sensor 19 may include one or more of a camera, radar sensor, laser, LIDAR sensor and ultrasonic sensor. Although one sensor 19 is shown in the schematic example of FIG. 1, more sensors may be utilized in some examples.

In some examples, the controller 20 may be an electronic control unit (ECU) that may include one or more individual electronic control units that control one or more electronic systems or subsystems within the vehicle 14. The controller 20, in some examples, may include one or more computing devices, each having one or more of a computer processor, memory, storage means, network device and input and/or output devices and/or interfaces. The controller 20 may be programmed to implement one or more of the methods or processes described herein.

In some examples, the controller 20 may be programmed with an algorithm used to detect corners or edges of the object 18 for determining whether a collision between the vehicle 14 and the object 18 is imminent. In some examples, knowing the host vehicle dimensions and/or those of a potentially attached trailer, and then using the current host vehicle's steering angle and velocity, a path trajectory can be calculated by the controller 20. The controller may then utilize this data for determining whether a collision between the vehicle 14 and the object 18 is imminent.

In some examples, the object 18 may include one or more of a vehicle, a wall, a curb, a barrier, a pillar, a construction object, and a garage object, such as a shelving unit or snowblower. In some examples, the object 18 is stationary.

In some examples, the vehicle response includes one or more of a vibration in a seat of the vehicle, an audiovisual response, a steering correction, a pulse in a steering wheel of the vehicle, blind spot alert, and a brake activation. In some examples, if the vehicle path shows a collision path with the object, an audio indicator that decreases as the driver adjusts to an appropriate steering angle can be used.

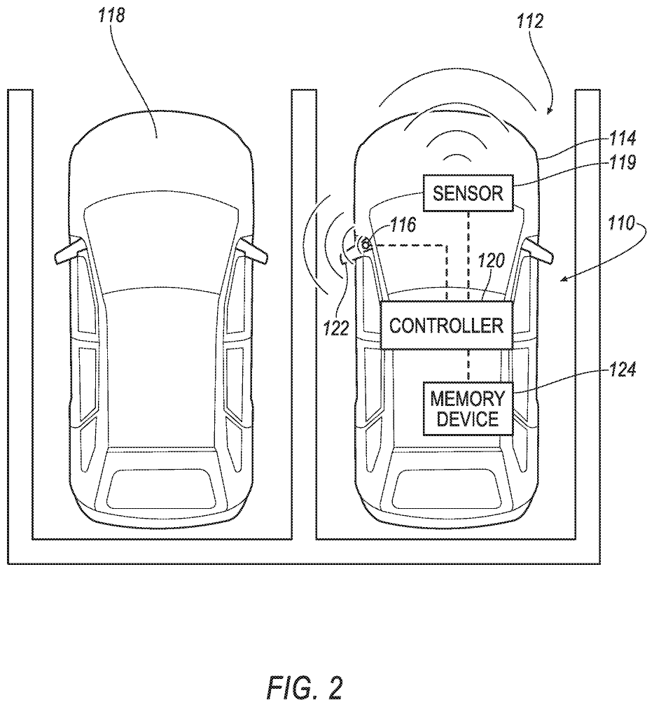

FIG. 2 schematically illustrates an example system 110 for assisting in the exit of a vehicle 114 from a parking spot 112. It should be understood that like reference numerals identify corresponding or similar elements throughout the several drawings. The system 110 includes a camera 116 on the vehicle 114 for obtaining one or more images of an adjacent vehicle 118 at the periphery of the vehicle 114. A sensor 119 senses a path of the vehicle 14 as the vehicle 114 exits the parking spot 112. A controller 120 may be programmed to determine whether a collision between the vehicle 114 and the vehicle 118 is imminent based on the sensed path and the one or more images and initiating a vehicle response if the collision is imminent.

In some examples, the camera 116 is disposed on or adjacent a side view mirror 122 of the vehicle. In some examples, the camera 116 includes a fish eye lens facing outward from the vehicle 114. In some examples, the camera 116 is located below the side view mirror 122 of the vehicle. In some examples, the camera 116 may be utilized with additional sensors for sensing the vehicle surroundings, including the examples disclosed herein. In some examples multiple cameras 116 may be utilized. In some examples, a camera 116 may be disposed on or adjacent each side view mirror (driver and passenger side) of the vehicle 114.

The system 110 may include a memory device 124 for storing images obtained from the camera 116. In some examples, the memory device 124 may be of any type capable of storing information, including a computing device-readable medium, or other medium that stores data that may be read with the aid of an electronic device, such as a hard-drive, memory card, ROM, RAM, DVD or other optical disks, as well as other write-capable and read-only memories. In some examples, the camera 116 obtains one or more images as the vehicle pulls into the parking spot. The images are then saved on the memory device 124 for providing information about the vehicle's surroundings when the vehicle 114 exits the parking spot 112. In some examples, the camera 116 may obtain one or more images as the vehicle 114 pulls into a parking spot 112, the vehicle 114 is then turned off, and, when the vehicle 114 is turned back on, the images obtained when the vehicle 114 pulled into the parking spot 112 and saved on the memory device 124 may be utilized to assist the vehicle 114 in exiting the parking spot 112.

In some examples, the controller 120 is configured to determine that the vehicle 114 is located in a parking area. In some examples, this is done when the vehicle transmission is shifted to or from “park.” In some examples, this is done when the vehicle 114 is turned on. In some examples, this is done by communication with a global positioning system. In some examples, this is done by sensing vehicle speed or other parameters. In some examples, this is done by sensing the ignition has been turned on.

In some examples, the systems and method disclosed may be utilized outside of parking environments, such as in low-speed cornering situations. In some examples, the controller 120 may sense that the vehicle has come to a stop or a near stop and may begin cornering assistance.

Although one sensor 119 is shown in the example, multiple sensors 119 may be utilized in some examples.

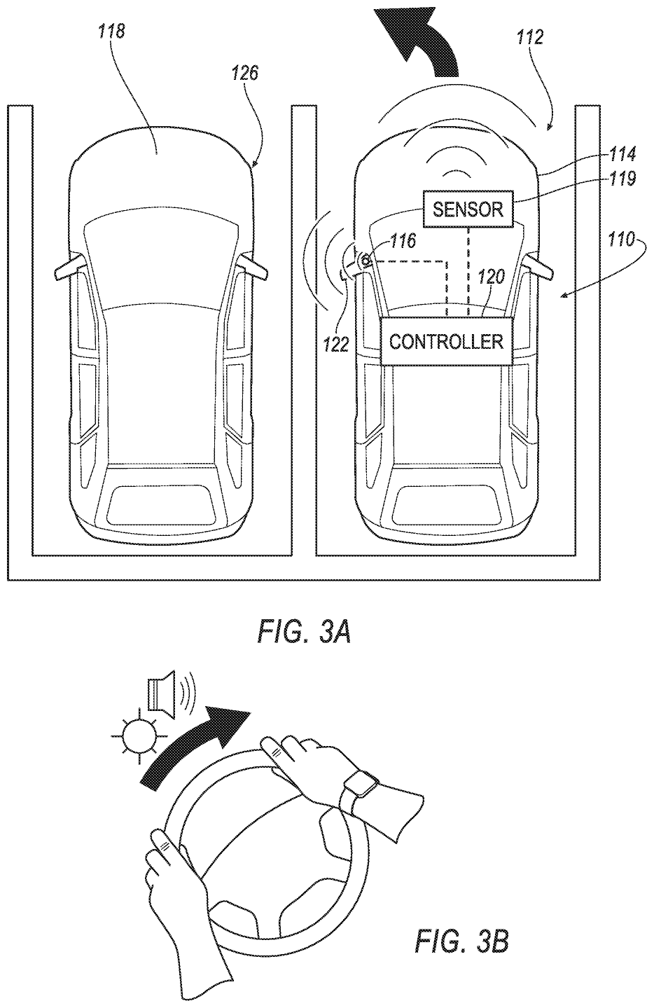

FIG. 3A schematically illustrates the vehicle 114 exiting the parking spot 112. The sensor 119 senses that the vehicle 114 will have a path turning to the left. The camera 116 obtains one or more images of the vehicle's surroundings, including the vehicle 118. The controller 120 determines whether a collision with the vehicle 118 is imminent. In some examples, the controller 120 may be programmed with host vehicle dimensions for determining whether a crash is imminent. In some examples, the controller 120 utilizes data related to the host vehicle 114 from the camera 116 or other sensors for determining whether a crash is imminent. In some examples, the controller also utilizes data about a trailer (not shown) attached to the host vehicle 114. In some examples, the controller 120 may be programmed to detect an edge or corner 126 of the vehicle 118 most likely to be collided with from the images provided by the camera 116.

In some examples, the controller 120 is programmed to utilize a structure from motion algorithm to estimate the three-dimensional structure of the object 118 based on a plurality of images obtained by the camera 116. Structure from motion is a photogrammetric range imaging technique for estimating three-dimensional structures from two-dimensional image sequences that may be coupled with local motion signals.

In some examples, the controller 120 may be programmed to utilize a semantic segmentation algorithm to detect the object 118 and/or calculate drivable surface on each side of the vehicle 114. Semantic segmentation utilizes image frames camera frames are to recognize various classifications in the vehicle environment, such as the driving surface, cars, pedestrians, curbs and sidewalks, at the pixel level. Semantic segmentation utilizes neural network based detection for image classification at the pixel level. In some examples, semantic segmentation utilizes every pixel of an image within an object class, which may include a specific type of object 118 or the surface between the object 118 and the vehicle 114 in some examples.

FIG. 3B schematically illustrates example vehicle responses if a collision is imminent. With reference to FIG. 3A, one or more of a steering torque overlay in the direction of steering correction, audio and/or visual indication may occur in some examples. Any of the vehicle responses disclosed herein may be utilized in some examples. In some examples, while the turning radius is not appropriate, the blind spot alert on the corresponding side rearview mirror may be illuminated.

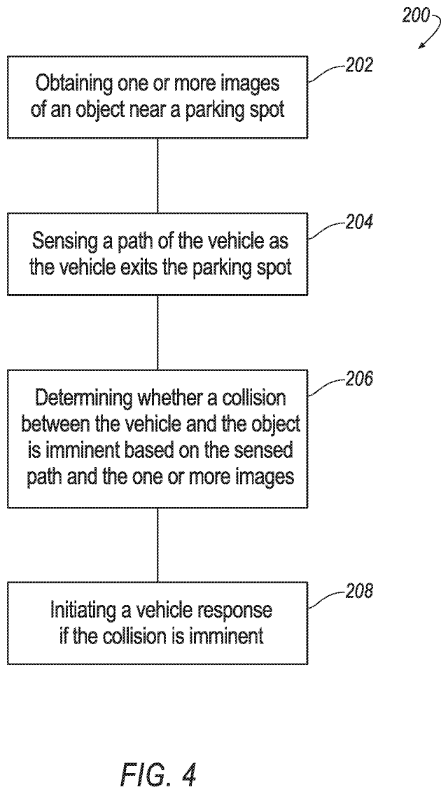

FIG. 4 illustrates a flow chart of an example method 200 for assisting in the cornering of a vehicle. At 202, the method 200 includes obtaining one or more images of an object near a parking spot. At 204, the method 200 includes sensing a path of the vehicle as the vehicle exits the parking spot. At 206, the method 200 includes determining whether a collision between the vehicle and the object is imminent based on the sensed path and the one or more images. At 208, the method 200 includes initiating a vehicle response if the collision is imminent.

In some examples, the method 200 includes determining that the vehicle is located in a parking area. In some examples, the method 200 includes sensing a path of a trailer of the vehicle as the vehicle exits the parking spot. In some examples, the method 200 includes determining whether a collision between the trailer and the object is imminent based on the sensed trailer path and the one or more images.

In some examples, the step 202 includes obtaining one or more images of an object near the vehicle as the vehicle pulls into the parking spot. In some examples, the method 200 includes storing the one or more images obtained as the vehicle pulls into the parking spot on a memory device.

In some examples disclosed herein, the systems and methods assist drivers to achieve an appropriate turning radius if a collision is predicted to be highly likely.

Although the different examples are illustrated as having specific components, the examples of this disclosure are not limited to those particular combinations. It is possible to use some of the components or features from any of the examples in combination with features or components from any of the other examples.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

1. A method for assisting in an exit of a vehicle from a parking spot, the method comprising:
obtaining one or more images of an object near the parking spot as the vehicle pulls into the parking spot;
sensing a path of the vehicle as the vehicle exits the parking spot;
determining whether a collision between the vehicle and the object is imminent as the vehicle exits the parking spot, based on the sensed path and the one or more images; and
initiating a vehicle response if the collision is imminent.

2. The method as recited in claim 1, wherein the vehicle response includes one or more of a vibration in a seat of the vehicle, an audiovisual response, a steering correction, a pulse in a steering wheel of the vehicle, and a brake activation.

3. The method as recited in claim 1, the method comprising:
determining that the vehicle is located in a parking area.

4. The method as recited in claim 1, the method comprising:
sensing a path of a trailer of the vehicle as the vehicle exits the parking spot; and
determining whether a collision between the trailer and the object is imminent based on the sensed trailer path and the one or more images.

5. The method as recited in claim 1, wherein the object is an adjacent vehicle.

6. The method as recited in claim 1, wherein the object is a curb.

7. (canceled)

8. The method as recited in claim 1, the method comprising:
storing the one or more images obtained as the vehicle pulls into the parking spot on a memory device.

9. The method as recited in claim 1, wherein the vehicle response includes a steering correction.

10. The method as recited in claim 1, wherein the vehicle response includes a brake activation.

11. A system for assisting in an exit of a vehicle from a parking spot, comprising:
at least one camera on the vehicle for obtaining one or more images of an object near the parking spot as the vehicle pulls into the parking spot; and
a controller configured to determine, as the vehicle exits the parking spot, whether a collision between the vehicle and the object is imminent based on a sensed path of the vehicle and the one or more images, and to initiate a vehicle response if the collision is imminent; and
a memory device for storing the one or more images, wherein between a time the one or more images is stored in the memory device and a time the controller determines whether the collision is imminent, the vehicle is turned off and subsequently turned on.

12. The system as recited in claim 11, wherein the at least one camera is disposed on or adjacent a side view mirror of the vehicle.

13. The system as recited in claim 12, wherein the at least one camera includes a fish eye lens.

14. (canceled)

15. The system as recited in claim 14, wherein the one or more images are obtained as the vehicle pulls into the parking spot.

16. The system as recited in claim 11, wherein the controller is an electronic control unit (ECU).

17. The system as recited in claim 11, wherein the vehicle response includes one or more of a vibration in a seat of the vehicle, an audiovisual response, a steering correction, a pulse in a steering wheel of the vehicle, and a brake activation.

18. The system as recited in claim 11, wherein the controller is configured to determine that the vehicle is located in a parking area.

19. The mtehod of claim 1, further comprising storing in memory the one or more images, the storing occurring before the vehicle is turned off and subsequently turned on, wherein following the vehicle being turned on, performing the sensing the path, the determining whether the collision is imminent and the initiating the vehicle response using the one or more images stored in the memory device prior to the vehicle being turned off.
